(19) United States
(12) Patent Application Publication
(10) Pub. No.: US 2016/0042080 A1
(43) Pub. Date: Feb. 11, 2016

(54) Methods, Systems, and Apparatuses for Searching and Sharing User Accessed Content

(71) Applicant: Neeah, Inc., Santa Clara, CA (US)

(72) Inventor: Justin Tan Nguyen, Las Vegas, NV (US)

(21) Appl. No.: 14/822,799

(22) Filed: Aug. 10, 2015

Related U.S. Application Data
(60) Provisional application No. 62/035,296, filed on Aug. 8, 2014.

(51) Int. Cl. G06F 17/30; G06F 3/0484; H04L 29/08

(52) U.S. Cl. CPC G06F 17/30867; H04L 67/22; G06F 17/30554; G06F 17/30477; G06F 17/30882; G06F 3/04842

(57) ABSTRACT

A method for managing user accessed content comprises several steps. First, user accessed content is tracked on one or more computing devices. The user accessed content comprises one or more visited webpages. Next, a database is generated based on the tracked user accessed content. The database is stored on a server, where the server indexes information from the one or more visited webpages. A search phrase is searched for in the database on a certain one of the computing devices. The certain one of the computing devices and the server are connected via a network connection. Search results are transmitted to the certain one of the computing devices via the network connection. The search results are displayed on a display screen of the certain one of the computing devices.

### CROSS REFERENCE

This application claims priority from a provisional patent application entitled “Methods, Systems, and Apparatuses for Searching User Accessed Content” filed on Aug. 8, 2014 and having an Application No. 62/035,296. Said application is incorporated herein by reference.

### FIELD OF INVENTION

The disclosure relates to an electronic archiving system, and, more particularly, to methods, systems, and apparatuses for archiving, searching, analyzing, and sharing user accessed content.

### BACKGROUND

The internet, also referred to as the World Wide Web or web, has allowed for a greater degree of dissemination of data and research. Typically, a user can run various software programs (e.g., web browser clients, referred hereinafter as web browsers) on a computing device (e.g., a computer, tablet, smart phone, internet enabled devices, or other computing device) to connect to the web. The web browser can access servers connected to the web to retrieve webpages.

Each webpage has a unique address, or universal resource locator (“URL”) within the web that is accessible by utilizing transfer control protocol/internet protocol (“TCP/IP”) transactions via telecommunication networks. The address allows a web browser to connect and communicate with a hypertext transfer protocol (“HTTP”) server over the web.

Generally, a web search engine (e.g., Google, Yahoo, etc.) can be accessed by the web browser to search for webpages using a key word search. A user can click on any one of the search results to access the associated webpages for the search results. Each webpage visited is usually logged in a history file unless the web browser is in an incognito mode or have some other privacy mode enabled. If a user desires to revisit a particular webpage, the user may bookmark the page to store, in the case of browsers, the URL and page title, or in the case of note services (e.g., Evernote, OneNote, etc.), the URL and page content, for accessing later.

Sometimes users visit useful web sites and retain useful bookmarks. Quite often, however, the user forgets to make the positive action of adding the webpage to the bookmark list or, adds the bookmark and forgets about the bookmark later on. The web browser history function can automatically record each webpage visited and retains it for a period of time. Most users don't know about the history record that is automatically stored and even if they did, the record is entered only in chronological order, thus making it very hard to search. Even more so, some of the links in the history record may no longer be active for the user to access those particular webpages again.

URLs and its accompanying title (if any) may also not be descriptive enough to determine whether the associated webpage is relevant to a particular subject. If the user attempts to reopen a visited webpage, it would be very difficult to determine the URL address of the visited webpage from the web history record since the web history may have hundreds to thousands of URLs. Even though an ASCII search may be made of both the bookmark and history records, the URLs may not provide any textual clues between the particular subject and the respective webpage.

In some cases, the webpage is no longer accessible to any user at a later time. This can be extremely frustrating when reviewing your search history for something the user has seen. Some note taking programs allow for screen shots of webpages and some editing tools to allow the user to make notes directly on the screen shot of the saved webpage. However, this leads to a very clumsy approach and provides no hierarchal form when reviewing research. Also, this can be quite time consuming to go through all the steps to eventually save a screen shot onto a note taking program and add additional text to that screenshot to identify the important aspects of that screen shot.

Furthermore, web browsers and web browsing extensions do not have the ability to track user created documents that the user may be working on. For instance, if a user is concurrently using a web browser to conduct research, the user may want to record his/her notes on another program, e.g., a word processing program. The word processing document and the web history may have important roles in the research process but are not associated with each other in any logical way for the user to easily review later on or to share with other users. The user would have to go back between at least two computer programs, i.e., the web browser and the word processing document, to organize his/her notes, which can be quite frustrating and time consuming. There is also no hierarchal structure of the user's web history to aid the user in putting together his/her research in a coherent manner. The web browsing research can also be quite difficult to share with other users when the webpage does not support sharing through Twitter, Facebook, Gmail, or other social networking cites and/or email applications.

Therefore, it would be desirable to provide methods, systems, and apparatuses for automatically indexing and searching previously visited webpages and user content.

### SUMMARY OF INVENTION

Briefly, the disclosure relates to a method for managing user accessed content, comprising the steps of: tracking user accessed content on one or more computing devices, wherein the user accessed content comprises one or more visited webpages; generating a database based on the tracked user accessed content, wherein the database is stored on a server, and wherein the server indexes information from the one or more visited webpages; searching for a search phrase in the database on a certain one of the computing devices, wherein the certain one of the computing devices and the server are connected via a network connection and wherein search results are transmitted to the certain one of the computing devices via the network connection; and displaying the search results on a display screen of the certain one of the computing devices.

### DESCRIPTION OF THE DRAWINGS

The foregoing and other aspects of the disclosure can be better understood from the following detailed description of the embodiments when taken in conjunction with the accompanying drawings.

FIG. 1 illustrates a block diagram of an electronic archiving system of the present disclosure for searching user accessed content.

FIG. 2 illustrates a flow chart for an interaction search method of the present disclosure for searching user accessed content.

FIG. 3 illustrates a web browser having a graphical user interface of the present disclosure for searching a user's archived web history.

FIG. 4 illustrates a web browser having another graphical user interface of the present disclosure for searching a user's archived web history.

FIG. 5 illustrates a web browser having yet another graphical user interface of the present disclosure for searching a user's archived web history.

FIG. 6 illustrates a web browser having an extension program to enable various features of the present disclosure.

FIG. 7 illustrates a network for sharing user content to other users via social media networks.

FIG. 8 illustrates a web browser having a user interaction mode to review users' interactions regarding a particular webpage.

FIG. 9 illustrates a web browser having another user interaction mode to review users' interactions regarding a particular webpage.

FIG. 10 illustrates a web browser having a webpage interactions user interface of the present disclosure.

FIG. 11 illustrates a web browser having a dashboard user interface of the present disclosure.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

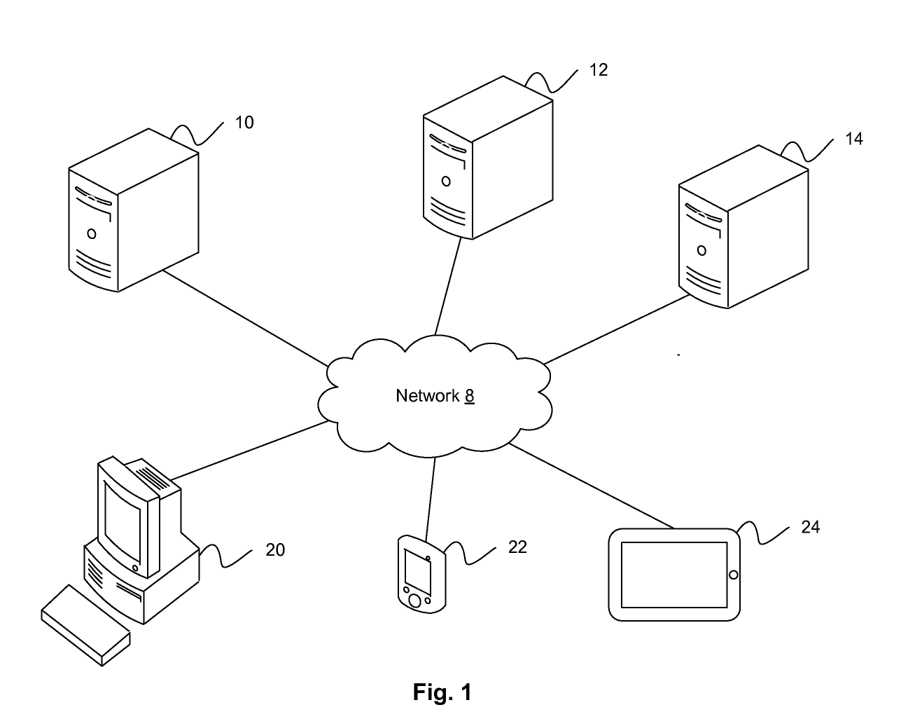

FIG. 1 illustrates a block diagram of an electronic archiving system of the present disclosure for searching user accessed content. An electronic archiving system of the present disclosure comprises a network 8, one or more servers 10-14, and one or more computing devices (e.g., a computer 20, a smart phone 22, and a tablet 24). The computing devices 20-24 can access the internet by connecting to the network 8 and retrieving webpages via the network 8. The electronic archiving system can be used to manage a user's content by archiving, searching, analyzing, and/or sharing user accessed content.

If a user is operating the computer 20, the user can initiate a session to search the internet for webpages related to a topic A. The user may use a search engine, e.g., Google, Yahoo, Bing, etc., to find relevant webpages related to the topic A. The user can then click on those search results to request access to the relevant webpages. Assuming the server 10 services those requests, the server 10 can transmit those webpages to the computer 20 for the user to view or otherwise use. Typically, the computer 20 can keep the URLs of the visited webpages on his/her computer 20 in the web browser history. The user may also even bookmark any one of the visited webpages for later retrieval.

The computer 20 can also automatically connect to the server 14 to transmit the URL addresses of the visited webpages and other information regarding the user's session. The server 14 can index the information from the visited webpages and the other information regarding the user's session. In particular, content (e.g., text, images, audio, and video) from the visited webpages can be indexed and stored by the server 14. In other embodiments, the computer 20 can locally index and store the content from the visited webpages as well. The text from the visited webpages can be stored in a database along with the location of the visited webpage that had such text. Any images, audio, and video from the visited webpages can also be characterized and then saved into the database along with the location of the webpage that had such content.

The server 14 can use the database to search the user's visited webpages that match any relevant search terms. The user can simply type in a search term on the service (e.g., in a web browser) or using a software application (e.g., an app on a smart phone) that is linked to the database. The search term is compared with the indexed content using a matching algorithm or other search algorithm. If any of the indexed content matches the search term, then the visited webpages that have the matched indexed content is retrieved and displayed to the user in a search result summary page. Thus, the user can quickly determine relevant visited webpages that the user may have viewed before. This allows the user to quickly trace through webpages that the user had previously viewed before. The electronic archiving system can also index and store other information from other documents, so that the user can quickly trace through those other documents as well.

User created documents can be indexed and stored in the database for quick retrieval. For instance, the user can draft or review a word processing document on the computer 20. When the user closes the word processing document, the text, images, and other content from the word processing document can be indexed and stored in the database. The word processing document in its native format or the location of the word processing document can also be saved by the database of the electronic archiving system. When a search term matches a term in the word processing document, the database can notify a user of that match and provide the location of the word processing document or a copy of that word processing document to the user.

The indexed content can be made available to a plurality of users. For instance, a user A can tag a session under a topic A, the indexed content that has the tag of the topic A can be searched by another user B. The database can associate indexed content with various tags, including by user, by terms in the content, by tags given to the indexed content, etc. In this manner, indexed content can be shared by multiple users who have access to the particular tag. Several users can work in collaboration to share joint research together by having a specific tag for that research. Alternatively, a user's session can be entirely tagged such that one or more other users, who have the appropriate viewing permission, can search and review the user's session. Privacy settings and sharing settings for a session, tag, or user content can be set by a user. The user can specifically select which other users can have access to the selecting user's indexed content.

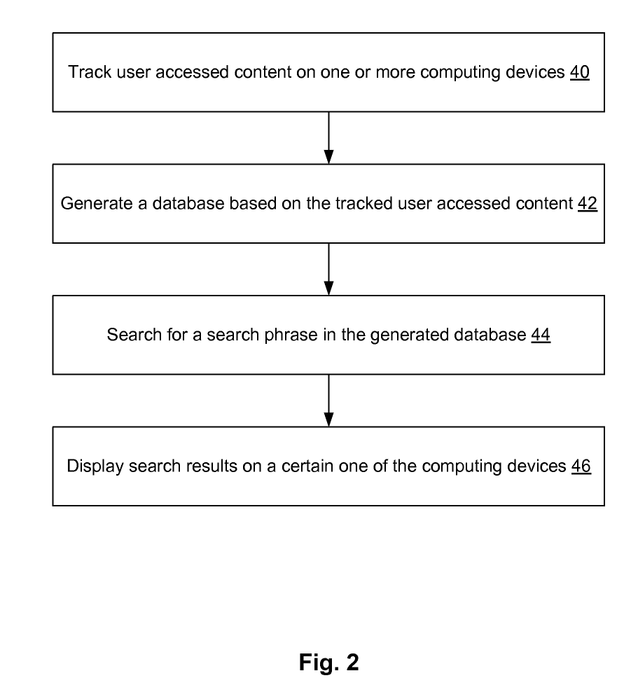

FIG. 2 illustrates a flow chart for a method of the present disclosure to manage user accessed content. A method to manage user accessed content comprises several steps. First, user accessed content on one or more computing devices can be tracked 40. Next, the tracked user accessed content is indexed and stored to generate a database 42. After generating the database, the user can search 44 for a search phrase in the generated database. The search results can be displayed 46 on a certain one of the computing devices of the user. Additional steps can be integrated between the above steps or after the above steps as will become apparent in the following embodiments of the present disclosure.

The accessed content can comprise webpages that were accessed by the computing device. During indexing, one or more of the following information can be stored on a remotely located server, including text from the accessed webpages, images from the accessed webpages, audio from the accessed webpages, and video from the accessed webpages. The search can query that indexed information for matching information in that index and the web address of the webpages that have such matching information. For instance, if a certain one of the stored text, images, audio, and video matches the search term, the respective webpage address for the certain one of the stored text, images, audio, and video is transmitted to the computing device for display in the displayed search result summary on the computing device. The search result summary can be in a list format that has links to the accessed webpages that match the search term.

The accessed content can also comprise user created documents, including word processing documents, spreadsheet documents, email documents, power point documents, adobe pdf documents, and other user created documents. The following information can be indexed and stored into a database, including text from the user created documents, images from the user created documents, audio from the user created documents, and video from the user created documents. If a certain one of the stored text, images, audio, and video matches the search term, then the respective user created document for the certain one of the stored text, images, audio, and video to the computing device is transmitted for display in the search result summary.

In the tracking step, various information can be tracked, including an address of the accessed content, an amount of time the accessed content was accessed by the user, a number of times the accessed content was accessed by the user, a number of users that accessed the accessed content, the number of times the accessed content was displayed in previous search results, etc. Furthermore, each of the accessed content can be assigned a priority level as a function of the respective tracked information. The search result summary of the accessed content can be further ordered in terms of the respective priority for the accessed content that have been identified as matching a certain search term.

The user's computing device can be used to log in to a server of the archiving computer system. Once logged in (either automatically through default settings of the computing device or manually by the user, the server can track the user's usage on the computing device. A user's usage details can be packaged by the user's computing device after a predefined amount of time and transmitted to the server via a network connection. Alternatively, the user's usage details can be sent from the user's computing device in near real-time to the server. The user can query the server via the network connection to search through the user's accessed content.

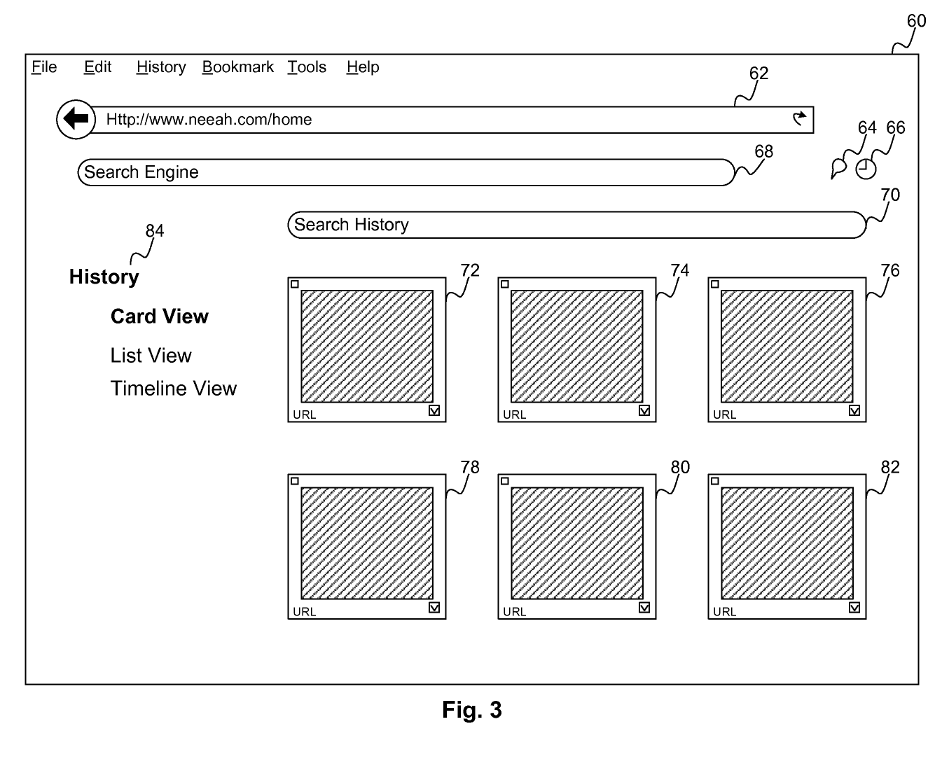

FIG. 3 illustrates a web browser having a graphical user interface of the present disclosure for searching a user's archived web history. A user can manage user accessed content that has been archived by an archiving system of the present disclosure via a history management homepage that is connected to the archiving system. The history management homepage can be accessed by a user on a web browser 60. The user can input to an address bar 62 of the web browser 60 the uniform resource locator (“URL”) of the history management homepage. The history management homepage can be hosted by the server or by another server that can query the database. The user can view, delete, change, and otherwise amend the user accessed content in the history management homepage. Any changes by the user can be saved by the server. The web browser 60 may run an extension program to allow for additional functionality to work in conjunction with the homepage.

The homepage comprises a discussion icon 64, a history homepage icon 66, a search engine bar 68, a history search bar 70, history cards 72-82, and a navigation panel 84. The discussion icon 64 can retrieve any past chat discussions the user has had regarding any webpages. The user may also subscribe to see what other users have posted about any certain webpages. For instance, assuming the user is part of a discussion group that comments on political articles, the user can subscribe to posts by other group members. When the discussion icon 64 is selected, the postings by the user and other group members can be listed for the user to review.

The history icon 66 allows for the user to return to the history management homepage. For instance, if the user types in a phrase to search, then search results will be populated and shown on the web browser 60. The user can get back to the history management homepage by selecting the history icon 66.

The search engine bar 68 allows for the user to input a search phrase to search. A results page (not shown) can retrieve search hits based on any web search engine, e.g., Google, Yahoo, etc. Along with the general search hits, another listing of user accessed search hits can be retrieved based on the user's accessed content that has been archived. Yet another listing of user accessed search hits can be provided in which the user accessed content was shared to other users and/or shared to the current user. Even more so, another listing of recommended search hits can be provided to the user based on the user's interaction and user accessed content that has been archived.

If the user decides to look for specific items in their user accessed content, the user can input a search phrase to the search history bar 70. A results page (not shown) can retrieve search hits based on the user's accessed content that has been archived and/or based on shared content. The search history bar 70 can be a further filter of the regular search engine bar 68.

When querying the user accessed content for a search phrase, the database can compare the search phrase with the user accessed content that has been archived to determine if there are any hits. For instance, assuming the user conducts research into baby safe products and archives some particular products, the electronic archiving system will archive the respective webpages of those baby products. The texts of those webpages will be archived as well. The search bar 68 and the history search bar 70 can look for particular words and phrases in those archived webpages. If the user searches for “safety certifications” in the history search bar 70, the searching algorithm will look through each of the user access content, including the archived webpages, to determine which ones mention safety certifications.

The history navigation panel 84 allows for the user access content to be viewed in various formats. In a card view, each webpage that was visited and archived are shown as cards 72-82. Each of the cards 72-82 provides a graphical representation of the linked webpage for the card, e.g., a screen shot of the webpage, image from the webpage, or other graphical representation to allow the user to associate the graphical representation to the webpage. The cards 72-82 can also have a section listing out a URL in shorthand and a sharing button for the respective webpage associated with each of the cards 72-82. The sharing button can link that respective webpage to other users either by a social media site, email, text, etc. When the user selects one of the cards 72-82, the respective archived webpage is retrieved and shown to the user. The user can select the history homepage icon 66 to return to the history homepage. The other views of the user access content are illustrated in the following figures.

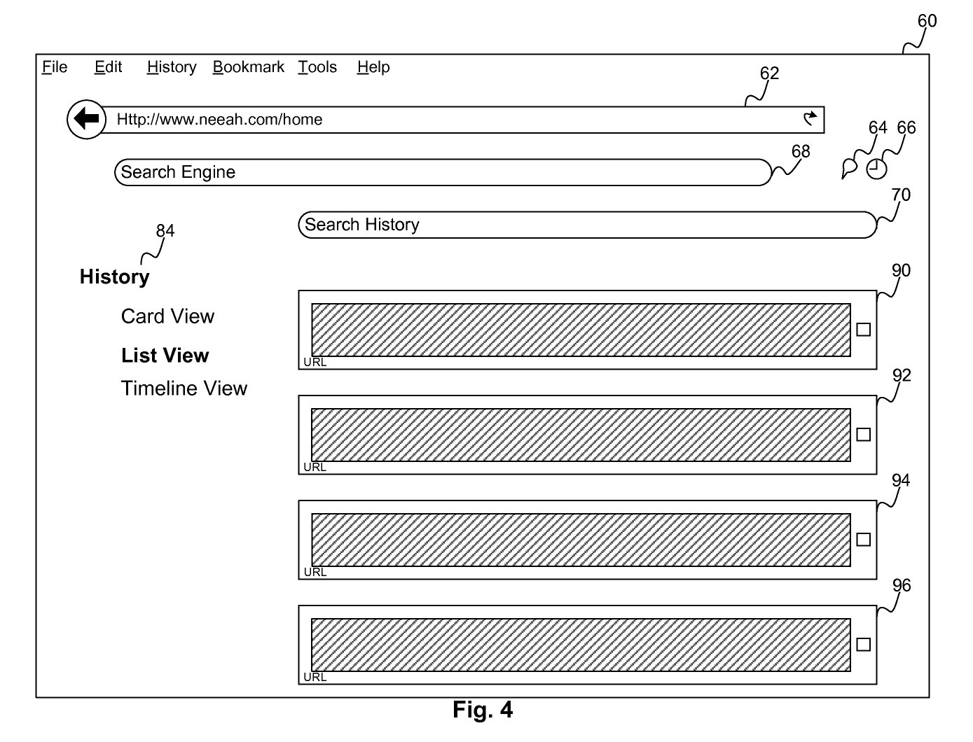

FIG. 4 illustrates a web browser having another graphical user interface of the present disclosure for searching a user's archived web history. In the history management homepage, a list view is selected to show the user accessed content that has been archived. The user accessed content is listed in a graphical form along a single column. The listings 90-96 can be listed in chronological order, by tags for the content, by subject matter of the content, by number of discussions for the content, and/or by another ordering method for the user accessed content. Each of the listings 90-96 can correspond to a webpage that the user has visited. The URL of that webpage can be listed on the listing as well as a share button on the listing.

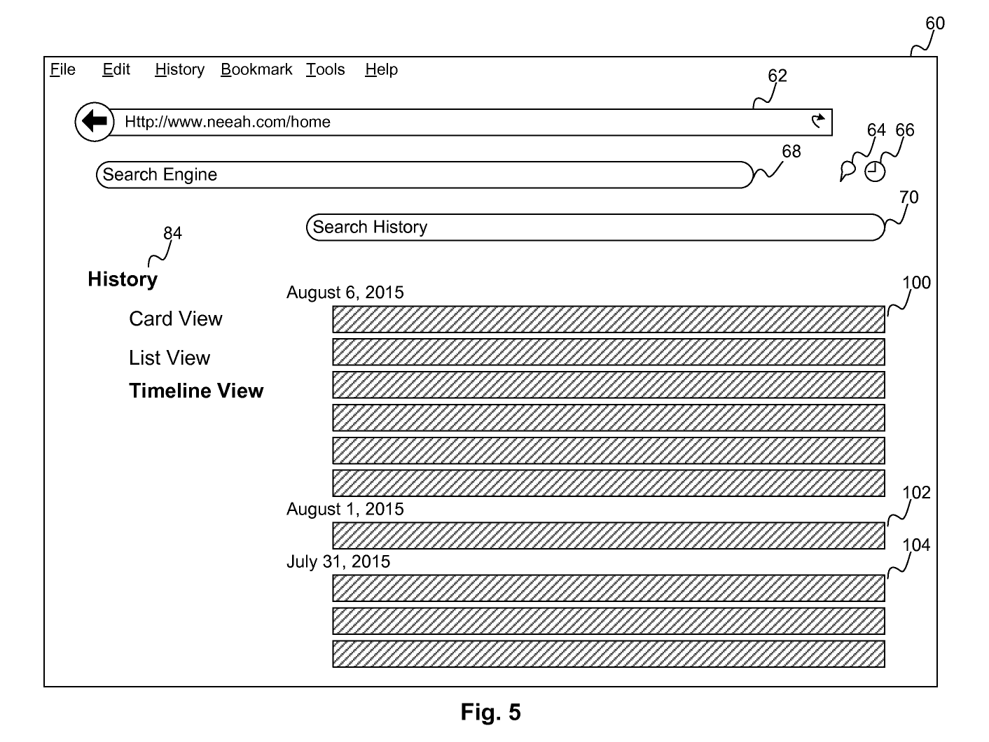

FIG. 5 illustrates a web browser having yet another graphical user interface of the present disclosure for searching a user's archived web history. In the history management homepage, a timeline view can be selected to show the user accessed content that has been archived in a purely list view in text. The URLs for the visited webpages can be listed in such list view. For instance, on Aug. 6, 2015 the user visited the webpages located at URLs 100. On Aug. 1, 2015, the user visited the webpage located at URL 102. On Jul. 31, 2015, the user visited the webpages located at URLs 104. The list view is a text oriented view of the user archived history. The user can select one of the views of the history navigation panel 84 as a default setting. The user can also toggle between the different views using the history navigation panel 84.

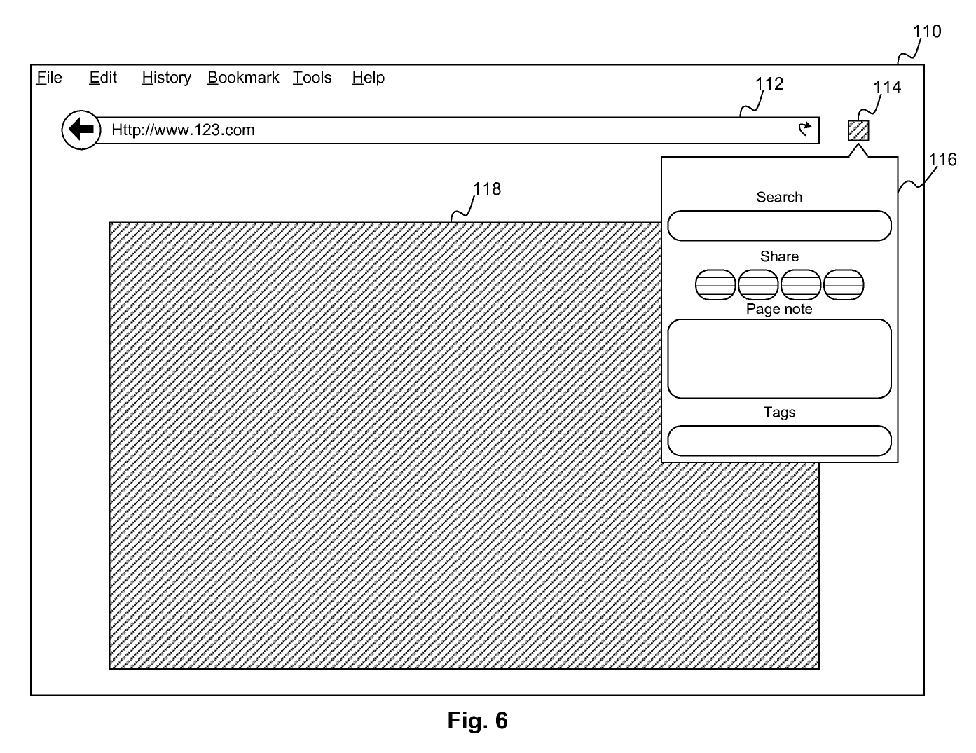

FIG. 6 illustrates a web browser running an extension program to enable social sharing functions of the present disclosure. A web browser 110 can have an extension program running along with the web browser to allow for the archiving and searching of user accessed content. The extension can have an extension icon 114 displayed on the web browser 110 for the user to access. When the extension is enabled, then any webpage that is visited via the web browser 110 can be archived by the extension. For instance, the server can track the webpages that are visited by the web browser 110. Furthermore, the server can access those pages and save any and all content from those webpages into a database of the server for indexing and retrieval. If the user wishes to access the archived webpage, the user can simply retrieve the archived version from the server rather than determine if the webpage is still active under its original URL.

When the extension icon 114 is selected, a drop down menu 116 is displayed providing various options that the user can select and apply. The drop down menu 116 comprises a search bar for searching user accessed content, a sharing mechanism to share the current webpage that the user is on via a social media site, email, text, or in another format to another user or forum, a note taking box, and a tags box.

The search bar can be similar to the previous mentioned search engine bar and history search bar. The user can simply enter a search phrase to the search bar of the drop down menu 116 to retrieve hits from his/her user accessed content or from the respective electronic archiving system.

The sharing mechanism allows for the user to share the webpage to other users or forums via a social media site, email, text, or in another format. Many webpages do not have sharing mechanisms to allow for sharing to a social media site. The extension program of the present disclosure allows for such interface by having an application programming interface (“API”) to allow for the user to login to the social media site from any webpage.

Furthermore, the user may add notes regarding a particular webpage that can be saved and associated to that particular webpage for later retrieval and/or sharing. The notes are typically associated to the current webpage that the user is on in the web browser 110. When the user reviews the history of user accessed content, any notes can be retrieved either by searching a user's online notebook, or by searching for the webpages that has the user's notes. Since the user's notes are archived together with the webpage, the electronic archiving system can use one item to locate the other, or vice versa, and return both items to the user for review or to even share to another user.

The user can also tag a webpage by inputting a key word or term in the tags box of the drop down menu 116. The tags can be used for searching and grouping of webpages having similar or same tags. Also, if the user allows another user to access certain tags, then webpages that have been tagged may be automatically shown to the other user and searchable by the other user. This is particularly useful for collaborations between multiple persons.

The present disclosure is not limited to extensions for a web browser. The present disclosure can apply to applications on a mobile computing device, e.g., a mobile phone, a tablet, a laptop, etc., smart electronics that can surf the web, e.g., a smart television, a Wi-Fi enabled music player, etc., or any other internet enabled devices. Also, the various platforms can be used and associated to a certain user such that the webpages viewed across platforms by the user can be archived by the electronic archiving system for the certain user. Thus, the user can have all his/her web enabled devices archive to a central database of the electronic archiving system for later retrieval, searching, and/or sharing.

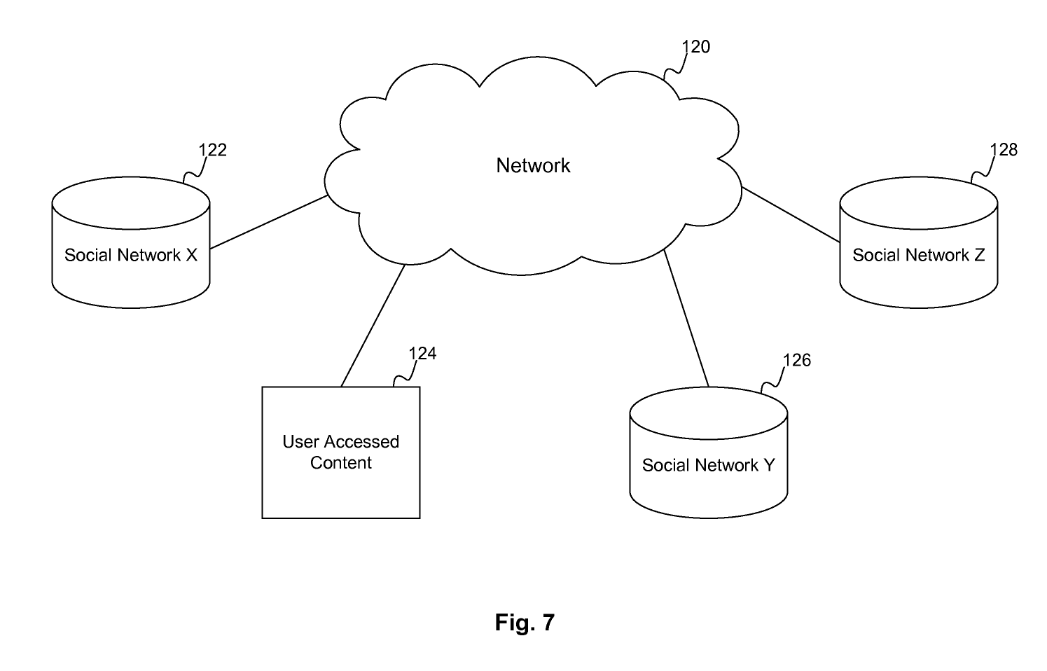

FIG. 7 illustrates a network for sharing user content to other users via social media networks. As mentioned previously, using a user accessed content system of the present disclosure, a user can share his/her user accessed content 124 to any social media site, e.g., social network X 122, social network Y 126, and social network Z 128 via the computer network 120.

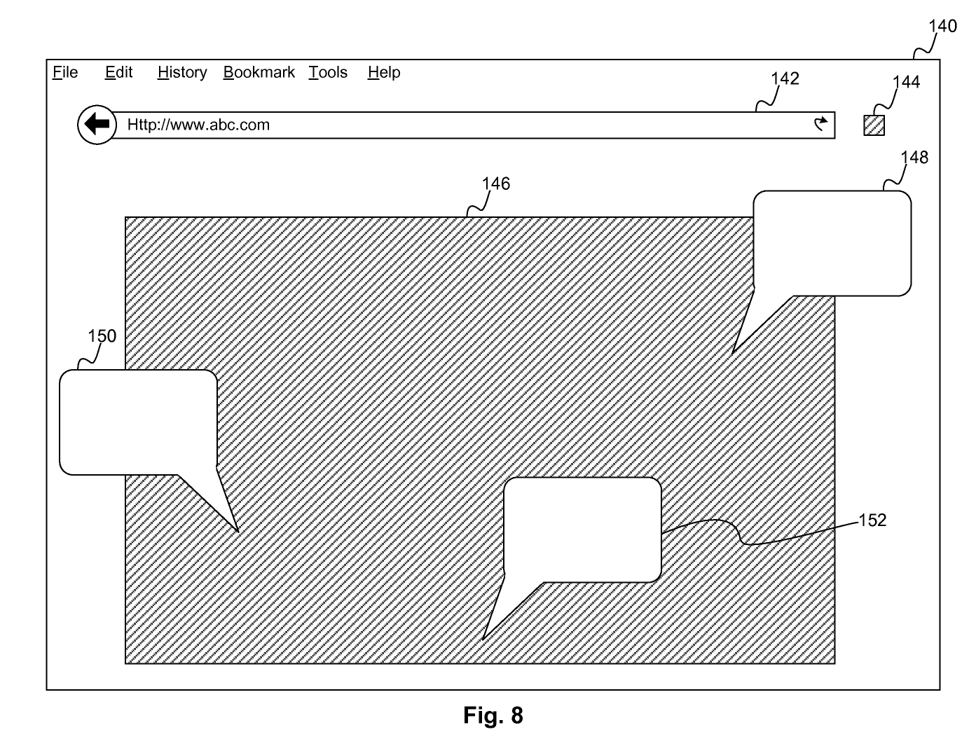

FIG. 8 illustrates a web browser having a mode to review user interactions regarding that webpage from other viewers. A web browser 140 having an address bar 142 and an extension icon 144 can be used to display an overlay of the user's comments with respect to a user accessed webpage. If multiple users comment about the same webpage, those comments can be overlaid on top of a display of that webpage. In this manner, all the various user interactions with that webpage can be presented on a single display for the users to review.

For instance, an article 146 is displayed on the web browser 140. The article is commented on by user A, user B, and user C. User A's comments can be overlaid on top of the display of the article 146 in text box 148. User B's comments can be overlaid on top of the display of the article 146 in text box 150. User C's comments can be overlaid on top of the display of the article 146 in text box 152. The comments 148-152 can be seen by all the users A, B, and C when each of them accesses the article 146 through the electronic archiving system. Privacy settings for the electronic archiving system can be set by each user so that the user's comments are not made public or are blocked from viewing by certain other user(s).

If one comment is in response to another comment, then those comments can be combined in a single text box with alternating comments from one user to the next user (similar to an instant message, e.g., gchat). Other interactions related to the webpage can also be displayed together with the users' comments including how many times the articles 146 was shared, by what means the sharing was performed, who the article was shared to, etc. In certain embodiments, the user comments can appear in real-time (e.g., instant messaging) or slightly delayed (e.g., bulletin board) so that other users may not see a user's comment immediately after the comment is made.

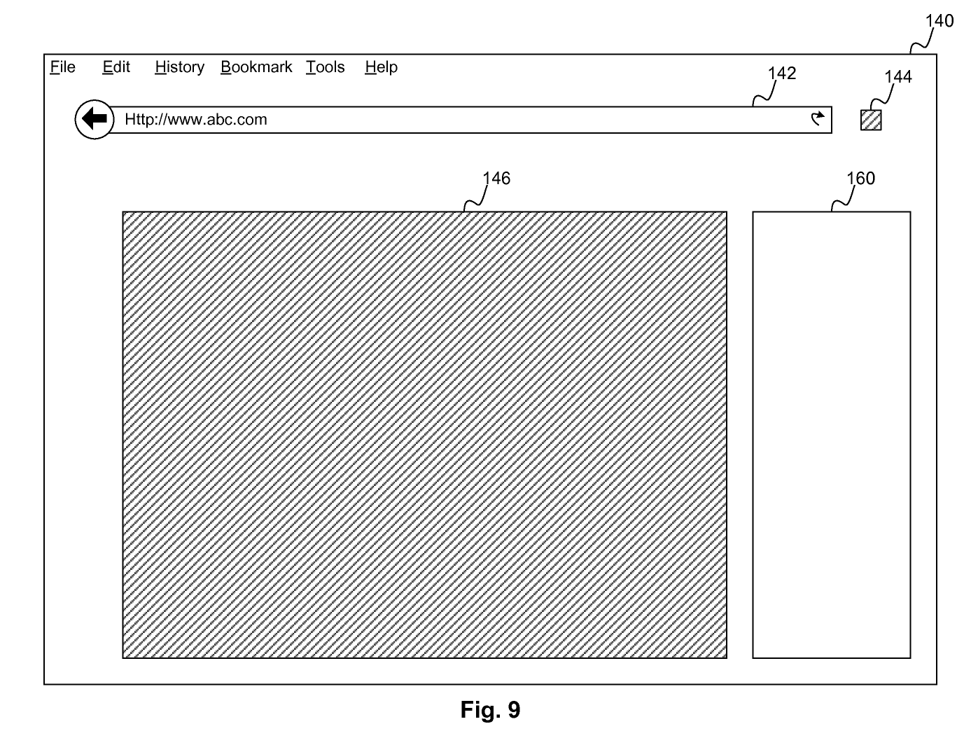

FIG. 9 illustrates a web browser having another user interaction mode to review users' interactions regarding a particular webpage. The users' comments to the article 146 can also be displayed in an instant message style text box 160. The text box 160 can be displayed adjacent to the article 146 (rather than overlaid on the article 146). Furthermore, the users' comments can be ordered in an instant message style in which the most recent is on the bottom of the text box near an input bar for the user to place his/her own comments. Older comments are bumped upwards on the text box 160. The comments may have a user name, time, and date indication for each comment.

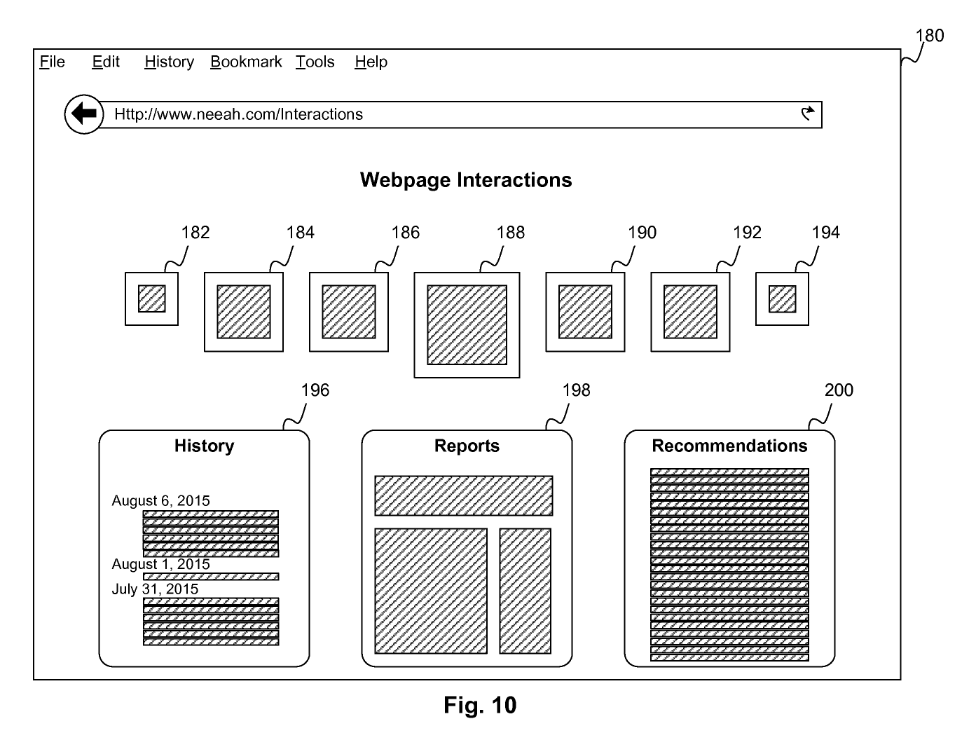

FIG. 10 illustrates a web browser having a webpage interactions graphical user interface (“GUI”) of the present disclosure. A web browser 180 shows a webpage interactions GUI for providing the user various functionality. A server of an electronic archiving system or another server connected to the server can host the webpage interactions GUI. The user can access the webpage interactions GUI via a network connection to one of the servers to access the database. The webpage interactions GUI provides a snapshot of the user's web interactions. The server of the electronic archiving system can provide an analysis of the user's search history and the search history itself to the user via the webpage interactions GUI. The user can review, amend, navigate, and otherwise interact with that information using the web interactions GUI.

The webpage interactions GUI comprises user accessed content icons 182-194, a history page 196, a reports page 198, and a recommendations page 200. The user accessed content icons 182-194, each represent an application, a website, or other electronic interaction that the user has visited, use, or otherwise interacted with. For instance, the icon 188 can link to the homepage of the electronic archiving system and list the number of user interactions. Furthermore, the icon 186 can link to the user's Twitter account and provide a number of recent interactions by the user to Twitter. Even more so, the icon 190 can link to the user's email account, e.g., Gmail, and provide a number of recent interactions by the user with his/her Gmail account.

The history page 196 can be a summary of visited websites by the user. The summary can be illustrated to the user in either a card view, listing view, and/or timeline view. The view can be selected by the user based on his/her preferences. From the history summary, the user can select one of those cards or listings to open the associated webpage from that selected result. This allows for a quick retrieval of recent webpages by the user.

The reports page 198 can provide a systematic and/or hierarchal view of the user's interactions. For instance, a dynamic matrix of searched-for products or subjects can be generated by the electronic archiving system and provided to the user via the webpage interactions GUI. If the user is searching for a particular product at different shopping websites, the electronic archiving system can automatically populate the dynamic matrix with product names and pricings for the user to easily review later on. Alternatively, the user can manually tag certain websites with product information and pricing to populate that information into the dynamic matrix. Thus, the user can retrieve a summary of the products and/or subject matters he/she has searched for in a handy matrix.

The user's interactions can be formed into a mind map by a mind mapping algorithm. The mind map can take many graphical forms including a tree structure. In the tree format, the mind map can stem starting from a main branch, which can signify the overarching subject matter. For instance, the main branch can be listed as a wedding. The mind map can have sub-branches from this main branch for the different vendor types for the wedding, including photographers, venues, catering companies, wedding dresses, flower vendors, bar providers, disco jockeys, etc. Under each sub-branch, e.g., venue, further sub-branches having links to specific websites directly related to that vendor type can be provided to the user via the mind map. In this manner, the user can be provided a tree structure that organizes the various user accessed content the user has come across in his/her research.

The recommendations page 200 can offer recommended products to the client based on the user's preferences and user accessed content. For instance, a recommendation algorithm, e.g., OutBrain, can be used to process the user's archived content to provide recommended websites, products, and services to the user. The user can also customize the recommendations for specific products and or subject matters.

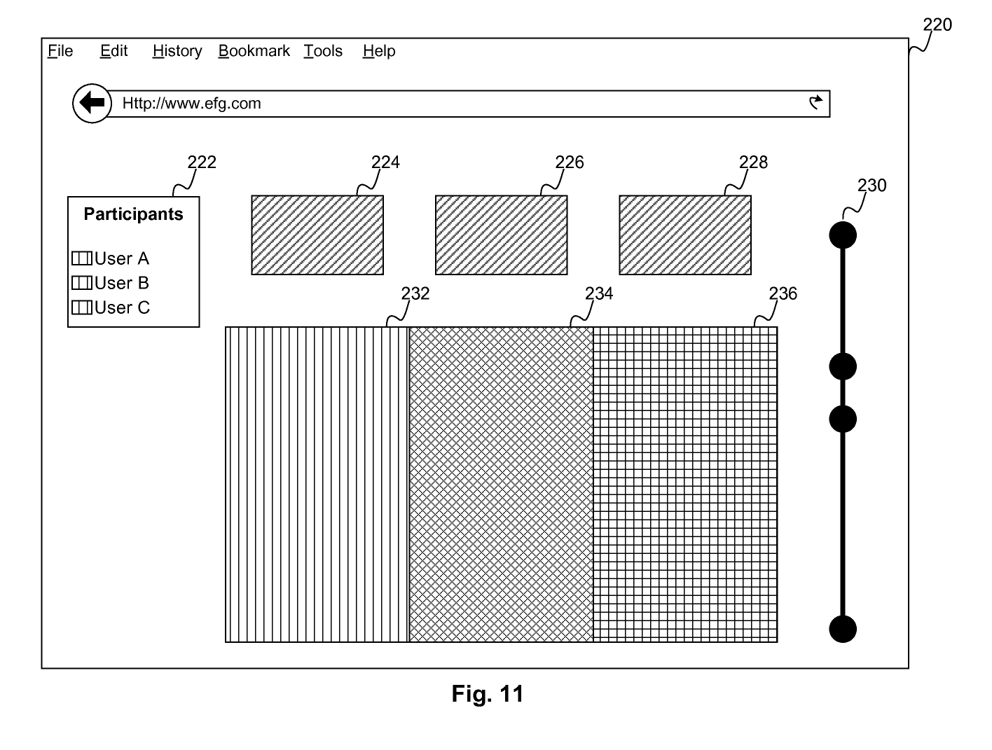

FIG. 11 illustrates a web browser having webpage dashboard graphical user interface of the present disclosure. A web browser 220 can be logged in to a webpage dashboard GUI of an electronic archiving system. The electronic archiving system has a server to host such dashboard GUI and is connected to the database via one or more servers of the electronic archiving system. The electronic archiving system can provide an analysis and summary of the various interactions by the user and anyone else the user is following regarding a certain webpage via the webpage dashboard GUI.

A web browser 220 can be used to visit an archived webpage. When the archived webpage is displayed in the web browser 220, the user can select the webpage dashboard GUI. The webpage dashboard GUI can be overlaid on top of the display of the webpage, or be momentarily brought to a new page showing the webpage dashboard GUI by itself.

The webpage dashboard comprises a participant list 222, icons 224-228, a timeline graphic 230, and comment windows 232-236. The participant list 222 states the users and any user images that have interacted with the particular webpage. The icons 224-228 provide a listing of the various social media sites, emailing services, or other forms that the webpage has been shared or interacted with. The timeline graphic 230 provides a date and time as to when the interactions have occurred. Interactions can include visiting the webpage, commenting on the webpage, sharing the webpage, or otherwise interacting with the webpage. The comment windows 232-236 how the various comments posted by users regarding the particular webpage.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skilled in the art.

We claim:

1. A method for managing user accessed content, comprising the steps of:
tracking user accessed content on one or more computing devices, wherein the user accessed content comprises one or more visited webpages;
generating a database based on the tracked user accessed content, wherein the database is stored on a server, and wherein the server indexes information from the one or more visited webpages;
searching for a search phrase in the database on a certain one of the computing devices, wherein the certain one of the computing devices and the server are connected via a network connection and wherein search results are transmitted to the certain one of the computing devices via the network connection; and
displaying the search results on a display screen of the certain one of the computing devices.

2. The method of claim 1 wherein, in the generating step, one or more of the following are indexed by the server: text from the visited webpages; images from the visited webpages; audio from the visited webpages; and video from the visited webpages.

3. The method of claim 1 wherein the search results are displayed on the certain one of the computing devices in one of the following views: a card view, a list view, and timeline view.

4. The method of claim 1 wherein a computer program is installed on the one or more computing devices, wherein the computer program packages the user accessed content, and wherein the computer program transmits the tracked user accessed content to the server for indexing in the database.

5. The method of claim 1 wherein one or more of the following information is indexed on the database: a web address of the user accessed content; an amount of time the user accessed content was viewed; a number of times the user accessed content was visited; a number of users that accessed the user accessed content; and the number of times the accessed content was displayed in previous search results.

6. The method of claim 1 wherein the certain one of the computing devices has a web browser and an extension program for the web browser to transmit user accessed content to the server, and wherein the extension program provides one or more of the following functions to the web browser: a searching function, a sharing function, a note taking function, a commenting function, and a tagging function.

7. The method of claim 1 wherein comments by users on a select webpage are shown along with any contents of the selected webpage.

8. The method of claim 1 wherein the database is used to generate a webpage interactions graphical user interface (“GUI”), and wherein the webpage interactions GUI comprises selectable application icons, a history page, a reports page, and a recommendations page.

9. The method of claim 8 wherein the database is queried to determine social media sites and email services that have been used by a user, wherein the determined social media sites and email services are transmitted to the certain one of the computing devices, and wherein the selectable application icons are linked to the determined social media sites and email services.

10. The method of claim 8 wherein the database is queried to determine visited websites of a user, wherein the determined visited websites are transmitted to the certain one of the computing devices, and wherein the history page is linked to the determined visited websites.

11. The method of claim 8 wherein the database is queried to determine a dynamic matrix for a user, wherein the determined dynamic matrix is transmitted to the certain one of the computing devices, and wherein the dynamic matrix is displayed for the user on the certain one of the computing devices.

12. The method of claim 8 wherein the database is queried to determine a mind map for a user, wherein the determined mind map is transmitted to the certain one of the computing devices, and wherein the mind map is displayed for the user on the certain one of the computing devices.

13. The method of claim 8 wherein the database is queried for recommended webpages for a user, wherein the recommended webpages are transmitted to the certain one of the computing devices, and wherein the recommendations page is linked to the recommended webpages

14. The method of claim 1 wherein the database is queried for information regarding a certain one of the visited webpages, wherein the queried information is used to generate a webpage dashboard graphical user interface (“GUI”), wherein the webpage dashboard GUI comprises a participant list, selectable icons, an activity timeline view of interactions, and a comments board, and wherein the webpage dashboard GUI is displayed along with the certain one of the visited webpages on the certain one of the computing devices.

15. The method of claim 14 wherein the database is queried to determine the participant list of users that have commented on the certain one of the visited webpages, wherein the determined participant list of users are transmitted to the certain one of the computing devices, and wherein the determined participant list of users is displayed on the certain one of the computing devices.

16. The method of claim 14 wherein the database is queried to determine social media sites and email services that have been used to share the certain one of the visited webpages, wherein the determined social media sites and email services are transmitted to the certain one of the computing devices, and wherein the selectable icons are linked to the determined social media sites and email services.

17. The method of claim 14 wherein the database is queried to determine the activity timeline for user interaction with the certain one of the visited webpages, wherein the activity timeline is transmitted to the certain one of the computing devices, and wherein the activity timeline is displayed on the certain one of the computing devices.

18. The method of claim 14 wherein the database is queried to determine user comments for the certain one of the visited webpages, wherein the user comments are transmitted to the certain one of the computing devices, and wherein the user comments are displayed on the certain one of the computing devices.

19. An electronic archiving system, comprising:
a server having a database;
one or more user computing devices; and
a network,
wherein the network connects the server and the one or more computing devices,
wherein user accessed content on the one or more computing devices is tracked by the server,
wherein the user accessed content comprises one or more visited webpages by the one or more computing devices,
wherein the database is based on the tracked user accessed content,
wherein the database is stored on a server,
wherein the server indexes information from the one or more visited webpages to the database,
wherein a search phrase is searched for in the database on a certain one of the computing devices,
wherein search results are transmitted to the certain one of the computing devices from the server, and
wherein the search results are displayed on a display screen of the certain one of the computing devices.

20. The electronic archiving system of claim 19 further comprising:
a web browser running on a certain one of the computing devices;
an extension program for the web browser to transmit user accessed content to the server, wherein the extension program provides one or more of the following functions to the web browser: a searching function, a sharing function, a note taking function, a commenting function, and a tagging function;
a webpage interactions graphical user interface (“GUI”), wherein the webpage interactions GUI comprises selectable application icons, a history page, a reports page, and a recommendations page; and
a webpage dashboard graphical user interface,
wherein the database is queried to determine social media sites and email services that have been used by a user,
wherein the selectable application icons are linked to the determined social media sites and email services,
wherein the database is queried to determine visited websites of a user,
wherein the history page is linked to the determined visited websites,
wherein the database is queried to determine a dynamic matrix for a user,
wherein the dynamic matrix is displayed for the user on the certain one of the computing devices,
wherein the database is queried to determine a mind map for a user,
wherein the mind map is displayed for the user on the certain one of the computing devices, wherein the database is queried for recommended webpages for a user,
wherein the recommendations page is linked to the recommended webpages,
wherein the webpage dashboard GUI comprises a participant list, selectable icons, an activity timeline view of interactions, and a comments board,
wherein the database is queried to determine the participant list of users that have commented on the certain one of the visited webpages,
wherein the determined participant list of users is displayed on the certain one of the computing devices,
wherein the database is queried to determine social media sites and email services that have been used to share the certain one of the visited webpages,
wherein the selectable icons are linked to the determined social media sites and email services,
wherein the database is queried to determine the activity timeline for user interaction with the certain one of the visited webpages,
wherein the activity timeline is displayed on the certain one of the computing devices,
wherein the database is queried to determine user comments for the certain one of the visited webpages, and
wherein the user comments are displayed on the certain one of the computing devices.
